(19) United States
(12) Patent Application Publication
(10) Pub. No.: US 2026/0215373 A1
(43) Pub. Date: Jul. 30, 2026

(54) Baler Gearbox Output Shaft Flywheels

(71) Applicant: AGCO Corporation, Duluth, GA (US)

(72) Inventors: Shane A. Bollinger, Hesston, KS (US); Kelly B. Booton, Lehigh, KS (US); Patrick L. Cherney, Hesston, KS (US); John D. Russell, Pemberville, OH (US); Wayne Vogel, Fremont, MI (US)

(21) Appl. No.: 19/452,231

(22) Filed: Jan. 17, 2026

Related U.S. Application Data
(60) Provisional application No. 63/750,973, filed on Jan. 29, 2025.

(51) Int. Cl. A01F 15/08; A01F 15/04

(52) U.S. Cl. CPC A01F 15/0841; A01F 15/04

(57) ABSTRACT

A baler has a plunger for compressing crop material in a baling chamber and a plunger drive. The plunger drive includes a connecting rod having a rear rod end connected to the plunger and a gearbox rotatably driving an output shaft with a crank-arm flywheel configured to rotate with the output shaft. A forward rod end of the connecting rod is pivotally connected to the crank-arm flywheel such that as the crank-arm flywheel rotates, the plunger reciprocates within the baling chamber. The crank-arm flywheel is formed having an unbalanced body with a weighted side and an unweighted side that has less mass than the weighted side. The connecting rod is connected to the crank-arm flywheel such that the unbalanced body acts to counter effects of the reciprocating motion of the plunger.

### CROSS REFERENCE TO RELATED APPLICATIONS

This application claims the benefit of the filing date of U. S. Provisional Patent Application 63/750,973, “Baler Gearbox Output Shaft Crank-Arm Flywheel,” filed January 29, 2025, the entire disclosure of which is incorporated herein by reference.

### BACKGROUND OF THE INVENTION

### Field of Invention

This disclosure relates to agricultural harvesting machines such as balers and, more particularly, to a plunger drive that has crank-arm flywheel on a gearbox output shaft.

### Description of Related Art

Agricultural balers that gather, compress, and shape crop material into a bale are well known in the art. A baler that produces rectangular bales is often referred to as a square baler. Picking up and baling of material in a field is an internal aspect of farming and is an expensive and labor-intensive process. The material normally is forage such for example, hay, biomass, alfalfa, straw, coastal Bermuda, and corn stalks and is referred to herein as crop material. Typically, crop material picked-up by machinery and fed to a baling chamber where the crop material is compressed and tied to form bales. Conventional square hay balers include a bale forming chamber and a reciprocating plunger that slides into and out of the chamber. “Square” bales are often preferred in that the square-shouldered bales facilitate stacking, delivery and use and, as used herein, square bales means bales having square shoulders.

As the chamber receives loose hay material, the plunger slides into the chamber during a compaction stroke to compress the loose hay material into the form of a bale. Square balers usually utilize a compression system with a drive train that transmits power to the reciprocating plunger. The drive train includes a gearbox with one or two crank-arms and connecting rods which are attached to a plunger. During each rotation of the crank-arm, the plunger compresses the crop in a baling chamber as the plunger moves towards the rear of the baler.

Accordingly, the crank-arm applies a cyclic, reciprocating load to crop in order to make bales. This reciprocating motion can be burdensome for the tractor operator and/or tractor if the backward momentum of the plunger is enough to resist the forward motion of the tractor.

### BRIEF SUMMARY

The invention is directed to an agricultural baler having a plunger for compressing crop material in a baling chamber and a plunger drive. The plunger drive includes at least one connecting rod having a rear rod end connected to the plunger. The plunger drive has a gearbox rotatably driving at least one output shaft (204), and at least one crank-arm flywheel (206) configured to rotate with the at least one output shaft. A forward rod end (208) of the at least one connecting rod is pivotally connected to the crank-arm flywheel such that as the crank-arm flywheel is rotated by the gearbox, the connecting rods cause the plunger to reciprocate within the baling chamber. The crank-arm flywheel is formed having an unbalanced body (302) with a weighted side (306) and an unweighted side (308) of the body that has less mass than the weighted side (306). The connecting rod is connected to the crank-arm flywheel such that rotation of the crank-arm flywheel is timed such that as the crank-arm flywheel rotates, the unbalanced body with the weighted side and unweighted side acts to counter the reciprocating motion of the plunger.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

The above mentioned and other features of this invention will become more apparent and the invention itself will be better understood by reference to the following description of embodiments of the invention taken in conjunction with the accompanying drawings, wherein:

FIG. 1 is a side elevation view of an example baler machine configured to receive loose plant material and shape and secure the material into a bale;

FIG. 2 illustrates a perspective view of a portion of the plunger drive of the baler of FIG. 1;

FIG. 3 illustrates a crank-arm flywheel of the plunger drive of FIG. 2; and

FIG. 4 illustrates an exploded view of the crank-arm flywheel of FIG. 3.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms "left" or "right" are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail. In the description which follows and in certain passages already set forth, the principles of the present invention will be described in terms of "twine" and "knots" formed in such twine. While twine is used in the exemplary embodiment, the term binding material is intended to mean not only twine made from natural or synthetic fibers, but may also include metallic wire or other strapping material.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

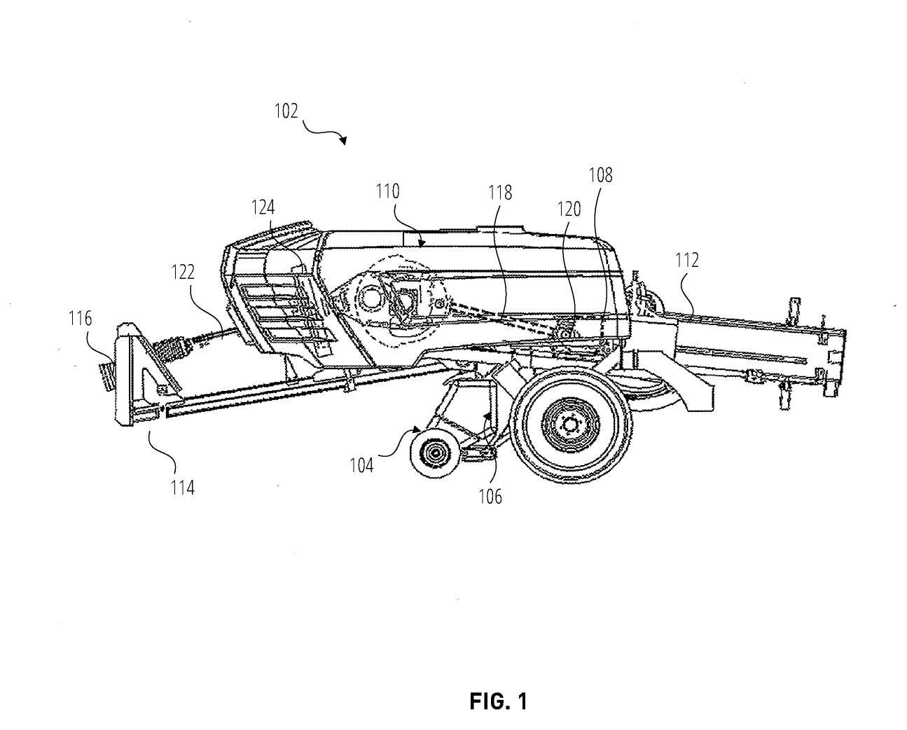

Referring to FIG. 1, an example agricultural baler 102 is shown into which embodiments of the present invention may be incorporated. Although the example baler 102 is a towed square baler, it will be appreciated that embodiments of the present invention may be incorporated into other types of balers (e.g., self-propelled) with few or no changes. Broadly, the baler 102 may be configured to move over a field and collect previously cut plant material and to compress, shape, and secure the collected plant material into a plurality of bales. The baler 102 may generally include a pickup assembly 104, a stuffer chute assembly 106, a reciprocating plunger 108 powered by a plunger drive 110, and a baling (or compression) baling chamber 112. Additionally, the baler 102 may be hitched to a towing vehicle (not shown) by a tongue 114, and power for operating the various mechanisms (e.g., the reciprocating plunger 108) of the baler 102 may be supplied by a power take-off (PTO) 116 of the towing vehicle. As is known in the art, the pickup assembly 104 may be configured to collect the cut plant material from the field. The stuffer chute assembly 106 may be configured to direct the collected plant material into position to be moved into the baling chamber 112. In one implementation, the stuffer chute assembly 106 may include a charge-forming duct extending from an inlet opening adjacent to the pickup assembly 104 to an outlet opening into the baling chamber 112.

The crop material is moved into the baling chamber 112 where the reciprocating plunger 108 may be configured to compress the plant into a growing bale. In one implementation, the plunger 108 may be configured to reciprocate within the baling chamber 112 in repeating compression and retraction strokes across the outlet opening of the charge-forming duct. As the plunger 108 retracts, the outlet opening is uncovered and an additional flake, charge, or other subunit of plant material enters the baling chamber 112, and as the plunger 108 contracts the outlet opening is covered and the additional subunit of plant material is compressed into the growing bale such that compacted bales are formed by making successive compaction strokes.

The plunger drive 110 directs power from the power take-off 116 to the plunger 108. The plunger 108 is connected to the plunger drive 110 with a pair of connecting rods 118. The plunger 108 is pivotally connected to each of the connecting rods 118 at rear rod ends 120. Input to the plunger drive 110 preferably includes a drive shaft 122 and a baler flywheel 124 as would be understood by one skilled in the art. The drive shaft 122 is operably supported by the tongue 114 connecting the baler 102 to the towing vehicle.

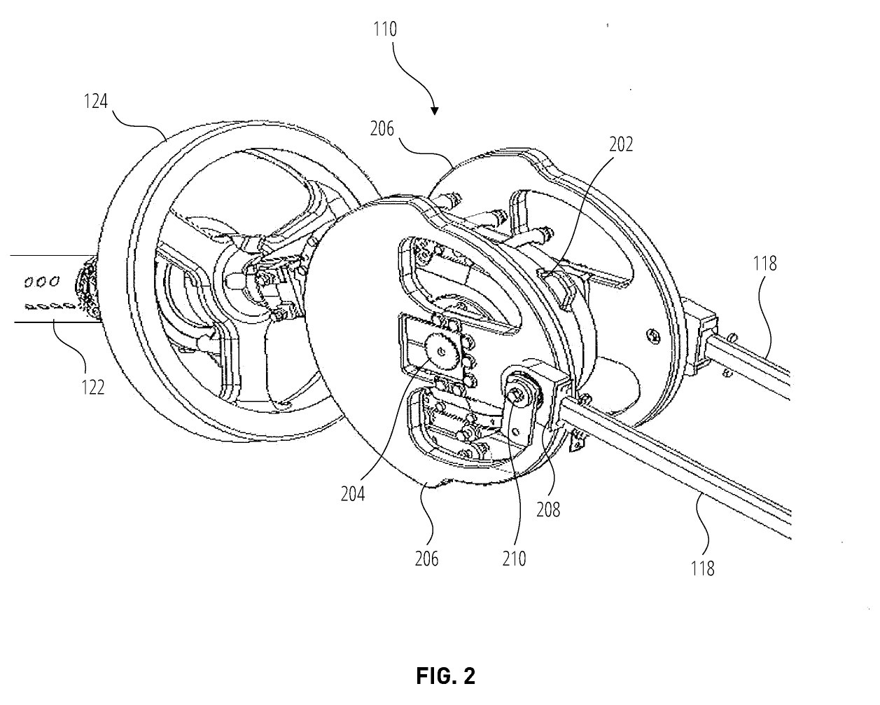

As best seen in FIG. 2, the baler flywheel 124 is connected to a gearbox 202. Each side of the gearbox 202 has an output shaft 204, but otherwise may be of conventional design used on balers. According to the invention, each output shaft 204 receives a crank-arm flywheel 206 configured to rotate with the output shaft 204. A forward rod end 208 of each of the connecting rods 118 is pivotally connected to its respective crank-arm flywheel 206 on a mounting hub 210. Thus, as the crank-arm flywheels 206 are rotated by the gearbox 202, the connecting rods 118 cause the plunger 108 to reciprocate within the baling chamber 112 thereby making alternating compaction and retraction strokes. As each new charge of loose crop material is introduced through the inlet of the baling chamber 112, the charge is moved rearwardly and compacted by the plunger 108 during a corresponding one of the compaction strokes. The compaction stroke forms the loose crop material into a compacted flake of the bale. Additional successive charges of loose crop material are moved into the baling chamber 112 and compacted to form a series of compacted flakes. Once a predetermined bale length is reached, the flakes are bound together with twine string by a tying mechanism (not shown).

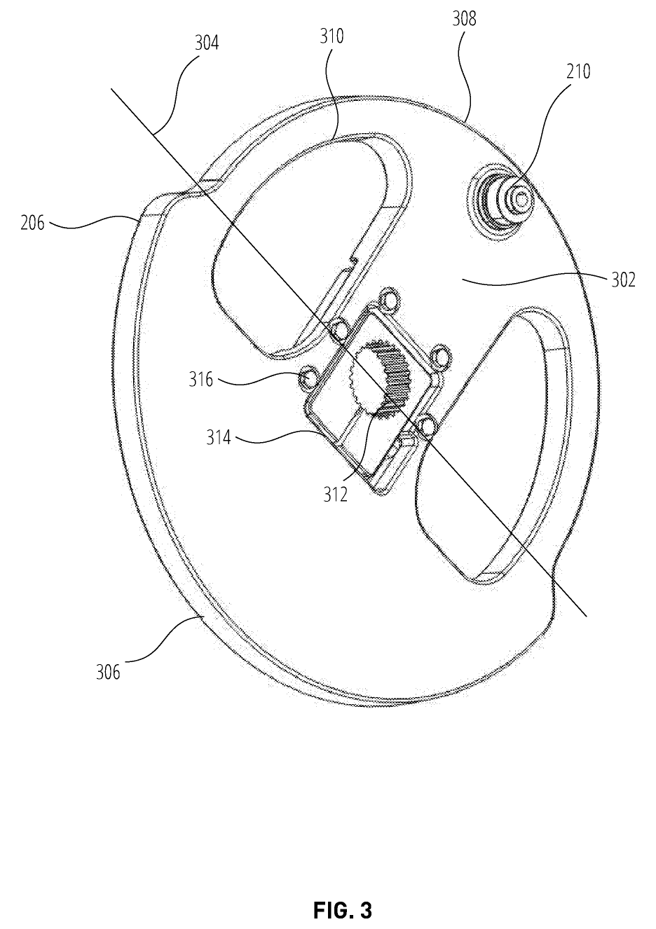

The crank-arm flywheel 206 is formed having an unbalanced body 302. As shown in FIG. 3, the body 302 is divided by an axis 304 such that there is a weighted side 306 of the body 302 and an unweighted side 308 that has less mass than the weighted side 306. In the illustrated embodiment, the body 302 uses cutout portions 310 and differing radii to form the weighted and unweighted sides 306, 308 of the crank-arm flywheel 206. Rotation of the crank-arm flywheel 206 is timed such that as the crank-arm flywheel 206 rotates, the unbalanced body 302 with the weighted side 306 and unweighted side 308 acts to counter and reduce the effects of the reciprocating motion of the plunger 108 by creating inertia that counteracts the reciprocating load of the plunger 108. Thus, the crank-arm flywheels 206 smooth out operation of the baler 102. The crank-arm flywheels 206 are desirably sized according to the size and speed of the plunger 108.

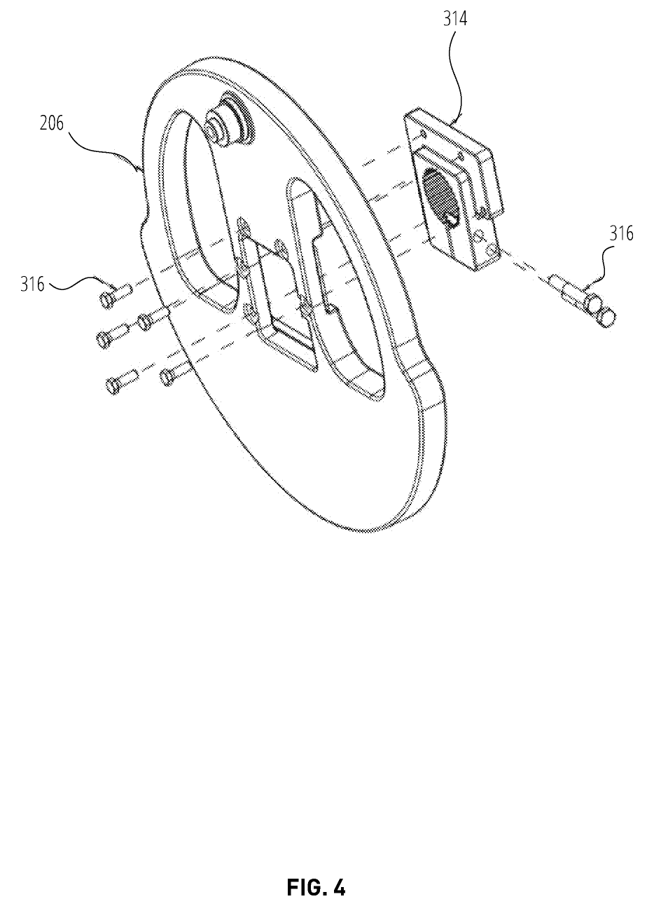

Turning also now to FIGS. 3 and 4, in the illustrated embodiment, the crank-arm flywheel 206 has a grooved mating opening 312 that interacts with a splined surface of the output shaft 204 of the gearbox 202 so as to transfer torque and maintain angular correspondence between the gearbox 202 and the crank-arm flywheel 206. In one embodiment, the mating opening 312 is formed as part of a key 314 that is mounted in the body of the crank-arm flywheel 206 with suitable fasteners 316.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. An agricultural baler comprising a plunger for compressing crop material in a baling chamber and a plunger drive, the plunger drive comprising:
at least one connecting rod having a rear rod end connected to the plunger;
a gearbox rotatably driving at least one output shaft; and
at least one crank-arm flywheel configured to rotate with the at least one output shaft, wherein a forward rod end of the at least one connecting rod is pivotally connected to the crank-arm flywheel such that as the crank-arm flywheel is rotated by the gearbox, the connecting rods cause the plunger to reciprocate within the baling chamber, wherein the crank-arm flywheel is formed having an unbalanced body with a weighted side and an unweighted side of the body that has less mass than the weighted side, and wherein the at least one connecting rod is connected to the crank-arm flywheel so that rotation of the crank-arm flywheel is timed such that as the crank-arm flywheel rotates, the unbalanced body with the weighted side and unweighted side acts to counter effects of the reciprocating motion of the plunger.

2. The plunger drive of claim 1 wherein the body uses cutout portions to form the weighted and unweighted sides of the crank-arm flywheel.

3. The plunger drive of claim 1 wherein the forward rod end attaches to a mounting hub on the body, wherein the mounting hub is positioned on the unweighted side such that rotation of the crank-arm flywheel acts to counter the reciprocating motion of the plunger.

4. The plunger drive of claim 1 wherein the body uses differing radii of the weighted and unweighted sides to form the weighted and unweighted sides of the crank-arm flywheel.

5. The plunger drive of claim 1 wherein the crank-arm flywheel has a grooved mating opening that interacts with a splined surface of the at least one output shaft of the gearbox so as to transfer torque and maintain angular correspondence between the gearbox and the crank-arm flywheel.

6. The plunger drive of claim 5 wherein the mating opening is formed as part of a key that is mounted in the body of the crank-arm flywheel.

7. The plunger drive of claim 1 wherein the gearbox has two output shafts, with each output shaft has a respective crank-arm flywheel.
